(19) United States
(12) Patent Application Publication
(10) Pub. No.: US 2014/0194118 A1
(43) Pub. Date: Jul. 10, 2014

(54) SEAMLESS TRANSITION OF DATA SERVICES IN A SINGLE-SIM MULTI-ACTIVE CELLULAR DEVICE

(71) Applicant: BROADCOM CORPORATION, Irvine, CA (US)

(72) Inventor: Yuan Liu, Holmdel, NJ (US)

(73) Assignee: BROADCOM CORPORATION, Irvine, CA (US)

(21) Appl. No.: 13/744,565

(22) Filed: Jan. 18, 2013

Related U.S. Application Data
(60) Provisional application No. 61/749,702, filed on Jan. 7, 2013.

(51) Int. Cl. H04W 36/00

(52) U.S. Cl. CPC H04W 36/0022
USPC 455/435.1; 455/436

(57) ABSTRACT

Systems, apparatuses and methods are described for seamless transition of data services in a single-SIM multi-active (SSMA) cellular device operating in a mixed technology cellular network. An SSMA device provides multiple virtual terminals capable of simultaneously maintaining multiple active services on different technology networks. The virtual terminals maintain service continuity by coordinating to seamlessly migrate data services from one network technology to another as a user geographically navigates a mixed technology network. This technology may be implemented in user equipment without modifying the various networks in the mixed technology network. This technology improves user experience and customer satisfaction with network providers.

This application claims the benefit of U.S. Provisional Application No. 61/749,702, filed on Jan. 7, 2013, which is incorporated by reference herein in its entirety.

### BACKGROUND

1. Technical Field

The subject matter described herein relates to services provided to a cellular terminal in a mixed technology cellular network.

2. Description of Related Art

There are a variety of cellular network communication system technologies, such as global system for mobile communications (GSM), Universal Mobile Telecommunications System (UMTS), Long Term Evolution (LTE) (including voice-over-IP LTE (VoLTE)), and wireless local area network (WLAN). GSM is considered a second generation or 2G technology, UMTS is considered a 3G technology, and LTE is considered a 4G technology. Each generation comprises a family of technologies or sub-technologies. For example, time-division synchronous code division multiple access (TD-SCDMA) and wideband CDMA (W-CDMA) are modulation schemes included in the 3G UMTS family of technologies.

Cellular network communication systems spanning a country or continent often comprise a patchwork of technologies and sub-technologies operated by one or more network providers. Accordingly, cellular user equipment (UE), such as a mobile terminal (MT) or mobile device, in a mixed technology network may be designed to obtain services (e.g., voice and data services) from more than one type or generation of cellular network technology. Network services, such as authentication, accounting, billing, and security services, are provided to each mobile device based on subscriber information used to identify and distinguish between mobile devices on a cellular network communication system. Subscriber information may be stored in a subscriber identity module (SIM) in each mobile device. Mobile devices may be single-SIM or multi-SIM devices.

A problem that arises as users move among a patchwork of technologies in a mixed technology network is disruption in the continuity of their services. These disruptions may include long lag times in re-connecting disconnected services. Such disruptions reflect poorly on network providers who provide customer service to users.

### BRIEF SUMMARY

Systems, apparatuses and methods are described for seamless transition of data services in a single-SIM multi-active (SSMA) cellular device operating in a mixed technology cellular network, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an exemplary embodiment of a single-SIM, dual-active cellular terminal

FIG. 2A shows an exemplary mixed technology network, according to an exemplary embodiment.

FIG. 2B shows a block diagram of a device comprising an exemplary single-SIM, dual-active cellular terminal that is moved between first, second, and third locations, according to an exemplary embodiment.

FIGS. 3A and 3B shows a method of maintaining continuity by migrating service provided to user equipment among different technology networks in a mixed technology network, according to an exemplary embodiment.

FIG. 4 shows a flowchart providing a process for maintaining continuity by migrating service provided to user equipment among different technology networks in a mixed technology network, according to an exemplary embodiment.

Embodiments are described as follows with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

Reference will now be made to embodiments that incorporate features of the described and claimed subject matter, examples of which are illustrated in the accompanying drawings. While the technology will be described in conjunction with various embodiments, it will be understood that the embodiments are not intended to limit the present technology. The scope of the subject matter is not limited to the disclosed embodiment(s). On the contrary, the present technology is intended to cover alternatives, modifications, and equivalents, which may be included within the spirit and scope the various embodiments as defined herein, including by the appended claims. In addition, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the embodiments presented.

References in the specification to “embodiment,” “example” or the like indicate that the subject matter described may include a particular feature, structure, characteristic, or step. However, other embodiments do not necessarily include the particular feature, structure, characteristic or step. Moreover, “embodiment,” “example” or the like do not necessarily refer to the same embodiment. Further, when a particular feature, structure, characteristic or step is described in connection with an embodiment, it is submitted that it is within the knowledge of one skilled in the art to effect such feature, structure, or characteristic in connection with other embodiments whether or not those other embodiments are explicitly described.

Particular terms are used throughout the following description and claims to refer to particular system components and configurations. As one skilled in the art will appreciate, various skilled artisans and companies may refer to a component by different names. The discussion of embodiments is not intended to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection or through an indirect electrical connection via other devices and connections.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

Systems, apparatuses and methods are described for seamless transition of data services in a single-SIM multi-active (SSMA) cellular device operating in a mixed technology cellular network. An SSMA device includes a single subscriber identity module (SIM), and provides multiple independent virtual terminals capable of simultaneously maintaining multiple active services on different technology networks (is “multi-active”). The virtual terminals maintain service continuity by coordinating to seamlessly migrate data services from one network technology to another as a user geographically navigates a mixed technology network. Embodiments may be implemented in user equipment without modifying the various networks in the mixed technology network. Such embodiments improve user experience and customer satisfaction with network providers.

Certain type of services may be more resource-efficient on certain network technologies than other network technologies. For example, voice services are very efficient on 2G networks. In contrast, data services, such as browsing or multimedia streaming, are very efficient on 3G and 4G networks. Due to resource efficiency considerations, a network provider, a network user, or both, may decide to always perform certain services using certain more efficient technologies whenever possible. The services may be performed using less efficient technologies only when the more efficient technology is unavailable. For example, a network provider may require all data services be performed on 3G or 4G cells whenever they are available, switching data services to 2G cells only when 3G and 4G cells are unavailable.

In one embodiment, a device or apparatus, such as but not limited to user equipment (UE), comprises a mobile terminal (MT). The MT comprises a plurality of virtual terminals. A first configuration of the MT provides the plurality of virtual terminals. The virtual terminals are capable of simultaneously providing multiple active cellular network connections to multiple networks in a mixed technology network. The multiple networks comprise a first network having a first network technology and a second network having a second network technology different from the first network technology. A second configuration of the MT provides continuity of a service provided to the UE by migrating the service between the first and second networks.

Connections to the first and/or second networks may be used to provide one or more services, e.g., data service and/or voice service, to the UE. Simultaneous connections to different networks and service continuity may, but need not, be deployed concurrently. One connection may concurrently provide multiple services to the UE. Multiple services may also be provided by concurrent connections to the first and second networks. In this case, the multiple services provided to the UE through the single terminal may be split between the first and second networks using the plurality of virtual terminals.

In some embodiments, the UE may comprise a SIM common to the first and second virtual terminals. Also, in some embodiments, the UE may further comprise an application layer common to the first and second virtual terminals. The first virtual terminal may be provided by a first modem coupled to the SIM, coupled to the application layer, and configured to establish a first connection to the first network to provide the service. The second virtual terminal may be provided by a second modem coupled to the SIM, coupled to the application layer, and configured to establish a second connection to the second network to provide the service. Each connection to a network may be established by the UE registering with a network and each connection may be based on a connection context.

In some embodiments, the second configuration may comprise a service continuity logic that switches, transitions or migrates services between the plurality of independent virtual terminals. Service migration may be controlled, for example, by the service continuity logic, application layer, or applications a user interacts with. The service continuity logic may comprise a first service transition unit in the first virtual terminal and a second service transition unit in the second virtual terminal The first and second service transitions units may communicate with one another.

For example, when the service is being provided through the first connection, the service continuity logic may be configured to provide to the second modem the first registration information and connection context for the first connection. This may permit the second modem to be ready for migration of the service to the second connection if the first connection is severed or for any other reason to migrate the service. Likewise, when the service is being provided through the second connection, the service continuity logic may be configured to provide to the first modem the first registration information and connection context for the second connection. This may permit the first modem to be ready for migration of the service to the first connection if the first connection is restored or for any other reason to migrate the service.

Migration of the service from the first network to the second network uses the first registration information to perform a registration update on the second network. Similarly, migration of the service from the second network to the first network uses the second registration information to perform a registration update on the first network.

The service migrated between first and second networks may comprise a data service or any other service. One or both of the first and second virtual terminals may also provide additional services to the UE. One or more services may be migrated between them or may be fixed on only one network. For example, a data service may be migrated between first and second networks while a voice service may be fixed on the second network if the second network is widely available. In this case, the second virtual terminal may be configured to establish the second connection to the second network to provide a voice service in addition to the data service.

The first and/or second virtual terminals may also be configured to establish connections with additional networks other than the first and second networks. For example, the first virtual terminal may be configured to establish a third connection to a third network that has a third network technology different from the first and second network technologies. The third network may provide the service and/or additional services. Continuity of the service provided to the UE may be provided by migrating the service between the first, second and third networks. In one example, the first network technology may comprise Long Term Evolution (LTE), the second network technology may comprise Universal Mobile Telecommunications System (UMTS) and the third network technology may comprise global system for mobile communications (GSM).

In another embodiment, a method may comprise operating a device or apparatus, e.g., a UE, in a mixed technology network. The device and mixed technology network may be any type of device and mixed technology network described herein or known in the art. The device may comprise a mobile terminal having a single SIM, a first virtual terminal and a second virtual terminal The mixed technology network may comprise a first network having a first network technology and a second network having a second network technology different from the first network technology. The method may further comprise establishing a first connection between the first virtual terminal and the first network and establishing a second connection between the second virtual terminal and the second network. The first and second connections may be established concurrently to provide the same or different services. The method may further comprise providing continuity of a service to the device by migrating the service between the first and second networks.

When the service is being provided through the first connection, the service continuity logic may be configured to provide to the second modem the first registration information and connection context for the first connection. Likewise, when the service is being provided through the second connection, the service continuity logic may be configured to provide to the first modem the second registration information and connection context for the second connection.

The service may be migrated for a variety of reasons, e.g., loss of coverage of a particular network, a particular network providing better service than another network, etc. For example, upon receiving an indication of loss of the first connection, the method may further comprise migrating the service from the first network to the second network by using the first registration information to perform a registration update on the second network. As another example, upon receiving an indication of availability of the first network, the method may further comprise migrating the service from the second network to the first network by using the second registration information to perform a registration update on the first network. Since each of the first and second virtual terminals are aware of the registration and connection information, they can migrate a service by performing an update registration procedure on their respective network. This may entail network elements (e.g., cell towers) in different networks communicating with one another.

The service migrated between first and second networks may comprise a data service or any other service. One or both of the first and second virtual terminals may also provide additional services to the UE. For example, the method may further comprise providing a voice service to the device through the first or second connection.

The first and/or second virtual terminals may also be configured to establish connections with additional networks other than the first and second networks. For example, the method may further comprise establishing a third connection between the first virtual terminal and a third network having a third network technology different from the first and second network technologies. The method may further comprise providing continuity of the service provided to the device by migrating the service between the first, second and third networks. The method may further comprise providing third registration information and connection context for the third connection to one or both the first and second virtual terminals. The method may further comprise providing notice of change of service connection to an application layer for each migration of the service. The application layer may be common to the first and second virtual terminals.

In another embodiment, a system may comprise a mixed technology network and a device that obtains one or more services from the mixed technology network. The mixed technology network may comprise a first network having a first technology to provide a service to a device and a second network having a second technology to provide the service to the device. The first and second technologies are different, which creates the mixed technology network. The device may comprise one or more terminals. One of the terminals may comprise a plurality of virtual terminals. A first virtual terminal may comprise a first modem configured to establish a first connection to the first network. A second virtual terminal may comprise a second modem configured to establish a second connection to the second network. The first and second connections can be sequential and/or concurrent. The terminal may also comprise a service continuity logic configured to provide continuity of the service by migrating the service between the first and second connections.

In some embodiments, at least one of the first and second virtual terminals and at least one of the first and second networks are configured to provide an additional service to the device though at least one of the first and second connections. In some embodiments, the mixed technology network may additionally comprise a third network having a third technology different from the first and second technologies to provide a service to the device. The first modem may be further configured to establish a third connection to a third network. The service continuity logic may be further configured to provide continuity of the service by migrating the service between the first, second and third connections.

In some embodiments, the service continuity logic may be configured to provide first registration information and connection context for the first connection to the second modem. Also, the service continuity logic may be configured to migrate the service from the first network to the second network by using the first registration information to perform a registration update on the second network. Also, the service continuity logic may be configured to provide second registration information and connection context for the second connection to the first modem. Also, the service continuity logic may be configured to migrate the service from the second network to the first network by using the second registration information to perform a registration update on the first network.

Advantages of embodiments include reducing disruptions in service by maintaining connections through service migration, improving user experience and satisfaction with their UE and network providers, and reducing costs for users by using a single SIM design.

Embodiments of systems, devices and methods may be implemented in various architectures, each with various configurations. Several detailed features and embodiments are discussed below. In Section II, an exemplary single-SIM, dual-active cellular device is presented. In Section III, an exemplary system is presented. In Section IV, an exemplary method is presented. Exemplary embodiments will now be described with reference to the accompanying figures.

### II. Exemplary Single-SIM, Multi-Active Cellular Device

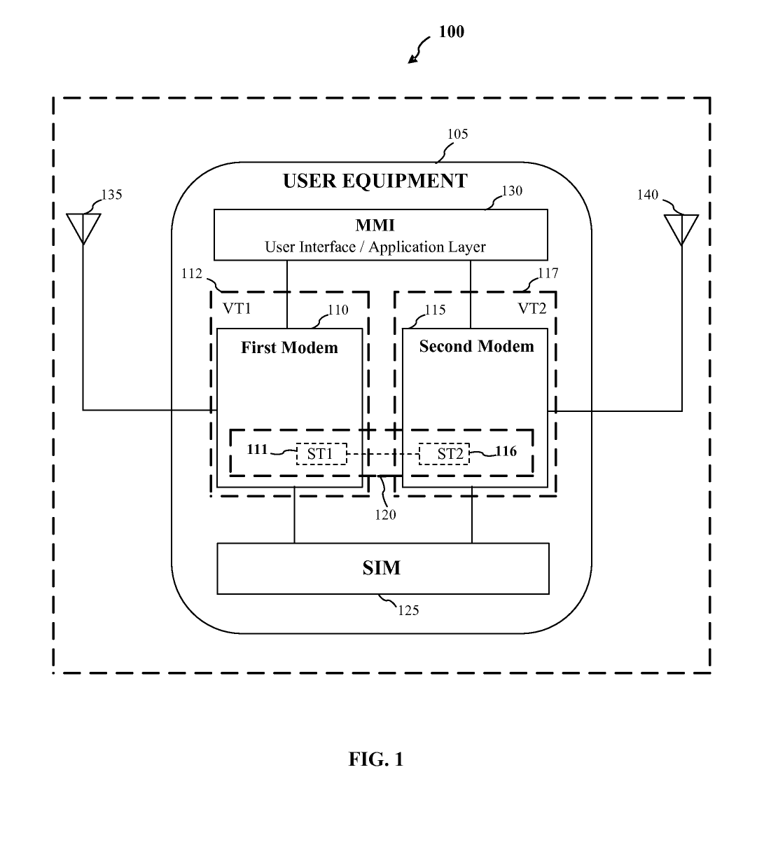

FIG. 1 shows a block diagram of an exemplary embodiment of a device 100 comprising a single-SIM, dual-active cellular terminal The dual-active aspect of device 100 is provided by two modems providing access to two basebands (e.g., baseband frequency processing logic), each modem with its own RF circuitry, antenna and processors, but sharing a common SIM and controlled by a common MMI (man-machine interface), UI (user interface), or application layer. Device 100 shown in FIG. 1 is not intended to be exhaustive. A wide variety of embodiments are possible. Device 100 is described in detail as follows.

As shown in FIG. 1, device 100 includes a user equipment (UE) 105. UE 105 may be one or both of a mobile terminal (MT) and a terminal equipment (TE). Any UE having an MT, such as a smart phone (e.g., an Apple® iPhone®, a phone that incorporates the Google Android™ platform, etc.), a cellular phone, tablet, netbook, laptop, or other mobile device, can communicate with a network. A network comprises any network, such as a cellular network. A cellular network may communicate with an intranet and/or an Internet, such as the World Wide Web (WWW). A TE, such as a personal computer (PC), camera, and other such device, may be connected to an MT to take advantage of a network connection. Phones in any form factor (e.g., compact phone, tablet phone, etc.), for example, may comprise both an MT and a TE.

Device 100 may comprise one or more terminals. UE 105 is simply one terminal (e.g., an MT) in device 100. UE 105 may comprise a single-SIM dual-active (SSDA) cellular terminal In this embodiment and/or in other embodiments, UE 105 may support more than two active connections to two different networks.

As shown in FIG. 1, UE 105 comprises a first modem 110, a second modem 115, a service continuity logic 120, a SIM 125, a man-machine interface MMI 130, a first antenna 135, and a second antenna 140. These features of UE 105 are described in detail as follows.

First modem 110 provides a first virtual terminal (VT1) 112, which may comprise a first virtual modem for data services, coupled to a first network (not shown in FIG. 1). First modem 110 may include RF (radio frequency) circuitry, one or more processors, and first antenna 135 used to make a first connection to a first network having a first technology and baseband frequency range. First modem 110 is coupled to service continuity logic 120, SIM 125, MMI 130, and first antenna 135. As indicated by first antenna 135, the first connection to one or more networks and communication thereon may be wireless. First modem 110 may communicate with more than one network. Examples of the RF circuitry, processor(s), and first antenna 135 used by first modem 110 to connect to and communicate on one or more networks is known to persons skilled in the relevant art(s) and is therefore not further addressed herein for reasons of brevity.

In some embodiments, first modem 110 may be configured to wirelessly connect to and communicate with one or more particular network technologies or sub-technologies, such as but not limited to one or more of the following technologies: LTE, UMTS (e.g., W-CDMA (wideband code division multiple access)), and GSM. First modem 110 or other components in UE 105 or device 100 may be configured to access one or more services from the one or more networks communicated with. Services may include, for example but not be limited to, data services and voice services. Data services may comprise, for example but not limited to, WWW browsing, email, multi-media-streaming, and data services used by any further type of mobile application hosted by device 100. Voice services may include voice services provided by network carriers or providers and/other providers of voice service, which may connect device 100 via first modem 110 with a second device through the one or more networks.

Second modem 115 provides a second virtual terminal (VT2 117), which may comprise a second virtual modem for data services, coupled to a second network (not shown in FIG. 1). Second modem 115 includes RF circuitry, one or more processors, and second antenna 140 to make a second connection to a second network having a second technology and baseband frequency range different from the first technology of the first network. Second modem 115 is coupled to service continuity logic 120, SIM 125, MMI 130, and second antenna 140. As indicated by second antenna 140, the second connection to one or more networks and communication thereon may be wireless. Second modem 115 may communicate with more than one network. The RF circuitry, processors and second antenna 140 used by second modem 115 110 to connect to and communicate on one or more networks is known to persons skilled in the relevant art(s) and is therefore not further addressed herein for reasons of brevity.

In some embodiments, second modem 115 may be configured to wirelessly connect to and communicate with one or more particular network technologies or sub-technologies, such as but not limited to one or more of the following technologies: LTE, UMTS (e.g., (W-CDMA)) and GSM. Second modem 115 or other components in UE 105 or device 100 may be configured to access one or more services from the one or more networks communicated with. Services may include, for example but not limited to, data services and voice services. Data services may comprise, for example but not limited to, WWW browsing, email, multi-media-streaming, and data services used by any further type of mobile application hosted by device 100. Voice services may include voice services provided by network carriers or providers and/other providers of voice service, which may connect device 100 via second modem 115 with a second device through the one or more networks.

Thus, first and second modems 110 and 115 provide first and second virtual terminals capable of simultaneously maintaining multiple active connections on multiple different technology networks. Connections to the first and/or second networks, and possibly additional networks, may be used to provide one or more services, e.g., data service and/or voice service, to device 100. A connection between one of first and second modems 110 and 115 to one network may concurrently provide multiple services to device 100. Multiple services may also be provided by concurrent connections to different networks. In this case, the multiple services provided to device 100 through UE 105 may be split between the different networks using the first and second virtual terminals provided by first and second modems 110 and 115.

One or both of the first and second virtual terminals provided by first and second modems 110 and 115 may also be configured to establish connections with additional networks other than the first and second networks. For example, the first virtual terminal provided by first modem 110 may be configured to establish a third connection to a third network that has a third network technology different from the first and second network technologies. Like the first and second networks, the third network may provide one or more migratory services and/or one or more fixed, network-specific or connection-specific services.

For resource efficiency or other reasons, one or both of the first and second virtual terminals may be specialized to behave in a “service-centric” way. For example, first modem 110 may be specialized to act as a preferred data service modem that connects to LTE or UMTS networks for data services. Second modem 115 may be specialized to act as a preferred voice service modem that connects to GSM networks for voice services. When the “preferred” modem for a particular service is out of coverage, the particular service can be migrated from the preferred modem to the non-preferred modem by service continuity logic 120.

Any existing or possible technique to establish a network connection may be used to establish a connection. For example, each connection to a network may be established by registering device 100 with the respective network and each connection may be based on a connection context. For simplification, even though a plurality of connection contexts may be necessary for a particular network to provide a plurality of services, a plurality of connections or connection contexts are collectively referred to herein as a connection.

Registration is a process whereby a device having TE informs a cellular network provider of an intention to request one or more services. The device requests and obtains relevant information from the cellular network to facilitate the one or more services. A connection is established after registration. A connection context is a logical representation of a connection between a device having TE and a network provider for the purpose of communication. In 4G LTE, this may be called a bearer context. In 3G UMTS and 2G GSM, this may be called a packet data protocol (PDP) context.

SIM 125 is a well-known structure providing subscriber information necessary to establish a connection and obtain services on a cellular network. UE 105 includes only one SIM. Thus, SIM 125 is common to and coupled to each of first modem 110 and second modem 115. First and second modems 110 and 115 use subscriber information provided by SIM 125 to access one or more services on a plurality of different technology networks sequentially and/or concurrently.

Man-machine interface (MMI) 130 provides a user interface (UI) for a user to interact with device 100. For example, if device 100 implements the Open Systems Interconnection (OSI) model, a user may interact with software applications running in the application layer of device 100. Herein, application layer is used to generally refer to a user interface regardless whether OSI is implemented. User interface applications, such as but not limited to a WWW browser application or a phone application, may access one or more services provided by one or more cellular networks. While device 100 may comprise more than one terminal, UE 105 includes one MMI 130. MMI 130, as well as its UI and application layer, is common to each of first modem 110 and second modem 115. First and second modems 110 and 115 comply with instructions generated in part by user input to MMI 130 and in part by logic implemented in applications and device 100. As a result, first and second modems 110 and 115 sequentially and/or concurrently access one or more services on a plurality of different technology networks.

Service continuity logic 120 is coupled to first and second modems 110 and 115. Service continuity logic 120 may be implemented, for example, by deploying first service transition (ST1) logic 111 in first modem 110, deploying second service transition (ST2) logic 116 in second modem 115, and coupling ST1 logic 111 and ST2 logic 116 together for interoperability, such as to coordinate operations by communicating with each other.

Service continuity logic 120 maintains, or attempts to maintain, continuity of one or more services provided by one or more networks in a mixed technology network. Service continuity logic 120 maintains service continuity by coordinating the transition or migration of data services from one network technology to another as a user geographically navigates a mixed technology network. In some embodiments, this continuity may be implemented in device 100 without modifying the various networks in the mixed technology network. In other embodiments, one or more networks may be modified to support or provide service continuity in a mixed network.

ST1 logic 111 and ST2 logic 116 may communicate with each other to coordinate service migration. As previously indicated, each connection to a network may be established by registering device 100 with the respective network. Each connection may be based on a connection context. As an example of ST1 logic 111 and ST2 logic 116 communicating, when a migratory service is being provided through the first connection, service continuity logic 120 or ST1 logic 111 may be configured to provide to second modem 115, e.g., via ST2 logic 116, the first registration information and connection context for the first connection. This may permit second modem 115 to be ready for migration of the service to the second connection if the first connection is severed or for any other reason to migrate the service. Likewise, when the service is being provided through the second connection, service continuity logic 120 or ST2 logic 116 may be configured to provide to first modem 110, e.g., via ST1 logic 111, the second registration information and connection context for the second connection. This may permit first modem 110 to be ready for migration of the service to the first connection if the first connection is restored or for any other reason to migrate the service.

To migrate the service from the first network to the second network, service continuity logic 120, or ST2 logic 116, uses the first registration information it was provided to perform a routing area update, also referred to as a registration update on the second network to transfer a registration on one network to another network. Similarly, to migrate the service from the second network to the first network, service continuity logic 120, or ST1 logic 111, uses the second registration information it was provided to perform a registration update on the first network.

The one or more services migrated between first and second networks may comprise a data service or any other service. One or both of the first and second virtual terminals may also provide additional services to the UE. One or more services may be migrated between networks or may be fixed on only one network. For example, a data service may be migrated between first and second networks while a voice service may be fixed on the second network. This may be preferable if the second network is widely available. In this case, the second virtual terminal may be configured to establish the second connection to the second network to provide a voice service in addition to the data service.

Note that the features or capabilities of simultaneous connections to different networks and service continuity by migration may, but need not, be deployed concurrently by device 100.

### III. Exemplary Single-SIM, Multi-Active System

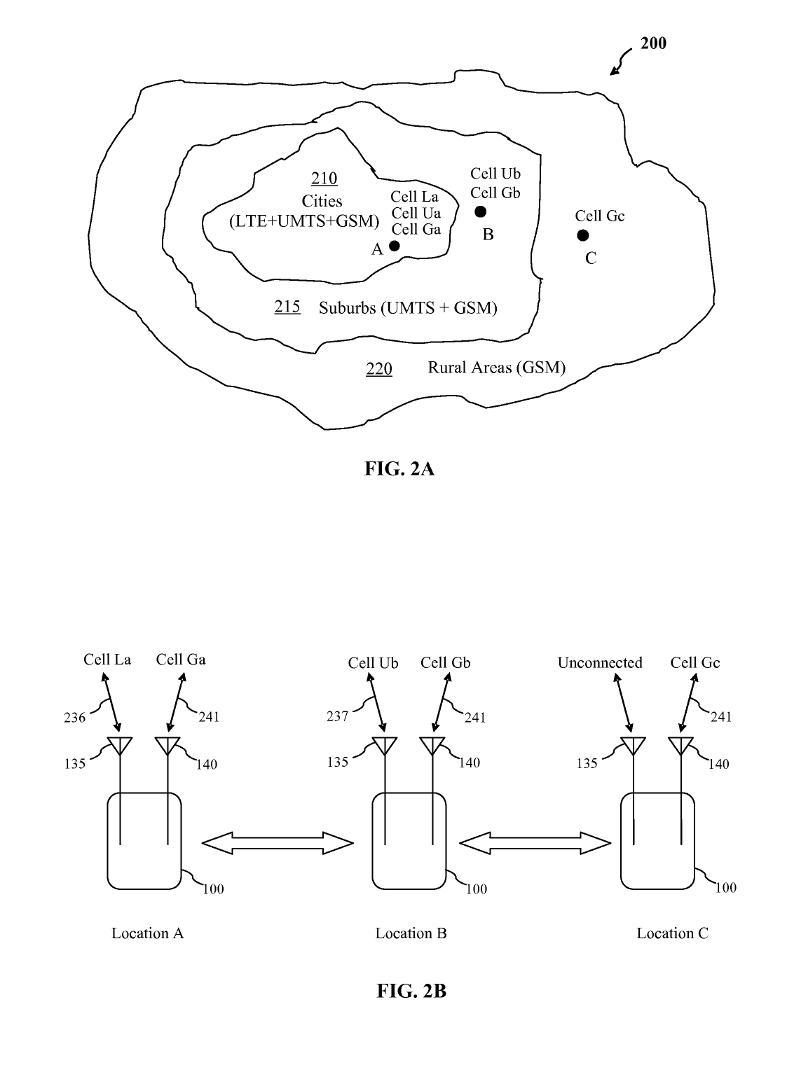

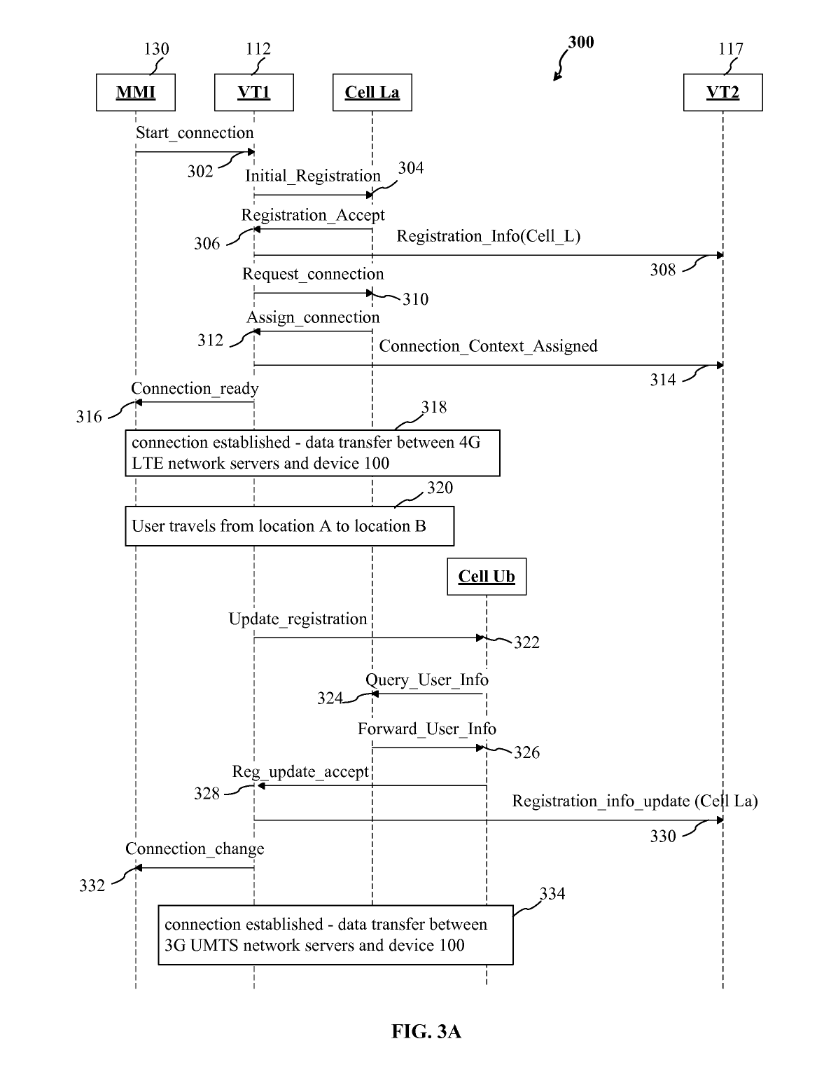

Embodiments of device 100 may operate in any type of mixed technology network to provide transition of services between networks. For instance, FIG. 2A shows an exemplary mixed technology network 200, according to an exemplary embodiment. Furthermore, FIG. 2B shows a block diagram of device 100 transitioning between networks, according to an exemplary embodiment. Mixed technology network 200 and device 100 may combine to form a system in which device 100 is enabled to communicate with other devices via network 200. Network 200 is operable to provide concurrent services to device 100 from one or more networks in or communicatively coupled to mixed technology network 200. Concurrent services may be provided by one network or may be split among different networks. Network 200 is also operable to provide service continuity by migrating one or more services to different technology networks.

As shown in this non-limiting example of FIG. 2A, mixed technology network 200 comprises a first region 210, a second region 215 and a third region 220. Regions 210, 215, and 220 may be configured to cover various geographical areas in any manner. For example, first region 210 may comprise a city, second region 215 may comprise suburbs surrounding the city, and third region 220 may comprise rural areas beyond suburbs. First region 210 may have multiple network technologies available. For example, first region 210 may have a 4G network such as LTE, a 3G network such as UMTS and a 2G network such as GSM available to provide services to mobile devices. Second region 215 may not have a 4G network such as LTE, but may have a 3G network such as UMTS and a 2G network such as GSM available to provide services to mobile devices. Third region 220 may not have a 4G network such as LTE or a 3G network such as UMTS, but may have a 2G network such as GSM available to provide services to mobile devices.

Each network technology may have one or more network elements in their respective regions to enable network connectivity with any number of devices, including hundreds, thousands, and even greater numbers of devices. For example, a network element may comprise a cell tower with an array of transceivers for one or more technologies.

In FIG. 2A, three locations are identified: location A in first region 210, location B in second region 215 and location C in third region 220. These are spot locations as a user of device 100 geographically traverses mixed network 200 from location A, through location B, to location C. FIG. 2B shows three views of device 100 (from left to right in FIG. 2B) corresponding to device 100 being located in location A, location B, and location C.

Although each network technology is capable of providing multiple types of services (e.g., voice service and data service) to device 100, in the embodiments shown in FIGS. 2A and 2B, one or more of a user (not shown), application(s), device 100, and mixed technology network 200 may have elected to split concurrently provided services between different networks. In other embodiments, services may be provided by the same network technology. In still other embodiments, multiple services may alternately be combined and split as necessary.

In this example, voice service is provided by 2G network GSM while application(s) or device 100 seek out available networks with the highest available data speeds to provide a data service. Thus, at location A, a voice service is provided through second connection 241 to the second virtual terminal of device 100 by 2G network GSM. This is indicated by cell Ga in FIG. 2A, which indicates an available GSM cell at location A. Also at location A, a data service is provided through first connection 236 (FIG. 2B) to the first virtual terminal of device 100 by 4G network LTE. This is indicated by cell La, which indicates an available LTE cell at location A. For instance, first virtual terminal 112 of device 100 may connect with a data service hosted by a server that is accessible though the 4G network LTE.

As the user moves from location A to location B in FIG. 2A, coverage by 4G network LTE is lost. To maintain coverage, the connection to the data service has to migrate to 3G network UMTS or 2G network GSM. Since 3G network UMTS provides faster data service and is available, device 100, an application executing on device 100 or service continuity logic 120 would select 3G network UMTS to migrate the data service.

In support of the continuity of data services by migration, ST1 logic 111 (FIG. 1) may be configured to provide first registration information and connection context for first connection 236 (FIG. 2B) to ST2 logic 116 (FIG. 1). Service continuity logic 120, and specifically second ST logic 116, may be configured to migrate the data service from 4G network LTE to 3G network UMTS by using the first registration information to perform a registration update on 3G network UMTS. Similarly, in other embodiments where voice service is a migratory service, registration and connection information for second connection 241 (FIG. 2) may be provided by ST2 logic 116 to ST1 logic 111.

Thus, at location B in FIG. 2A, a voice service is provided through second connection 241 (FIG. 2B) to the second virtual terminal of device 100 by 2G network GSM. This is indicated by cell Gb, which indicates an available GSM cell at location B. Also at location B, a data service is provided through migrated first connection 237 (FIG. 2B) to the first virtual terminal of device 100 by 3G network UMTS. This is indicated by cell Ub, which indicates an available UMTS cell at location B.

As the user moves from location B to location C, coverage by 3G network UMTS is lost. To maintain coverage, data service will have to migrate to the only available network, which in the current example is 2G network GSM.

In support of the continuity of data services by migration, ST1 logic 111 (FIG. 1) may be configured to provide first updated registration information and connection context for migrated first connection 237 (FIG. 2B) to ST2 logic 116. Service continuity logic 120, and specifically ST2 logic 116, may be configured to migrate the data service from 3G network UMTS to 2G network GSM by using the first updated registration information to perform a registration update on 2G network GSM. Similarly, in other embodiments where voice service is a migratory service, registration and connection information for second connection 241 (FIG. 2B) may be provided by ST2 logic 116 to ST1 logic 111.

Thus, as shown in FIG. 2B, at location C, a voice service is provided through second connection 241 to the second virtual terminal of device 100 by 2G network GSM. This is indicated by cell Gc, which indicates an available GSM cell at location C. Also at location C, a data service is provided through second connection 241 to the second virtual terminal of device 100 by 2G network GSM. This is indicated by cell Gc, which indicates an available GSM cell at location C. Of course, there may be multiple connections established between the second virtual terminal of device 100 and cell Gc, but for purposes of simplification, the connection(s) providing both voice and data services is/are referred to as second connection 241.

It can be seen that at location C, the first virtual terminal provided by first modem 110 is disconnected or unconnected because there is no available UMTS or LTE cell at location C. However, data services were successfully migrated to provide data service continuity for device 100.

In support of the continuity of data services by future migration, ST2 logic 116 may be configured to provide second registration information and connection context for second connection 241 to ST1 logic 111. This information may be utilized for migration when the user returns to an area with coverage by a network technology that first modem 110 can connect to, such as 3G network UMTS or 4G network LTE in this example. In this event, service continuity logic 120, and specifically ST1 logic 111, may be configured to migrate the data service from 2G network GSM to 3G network UMTS or 4G network LTE by using the provided registration information to perform a registration update on 3G network UMTS or 4G network LTE, respectively.

### IV. Exemplary Single-SIM, Multi-Active Method

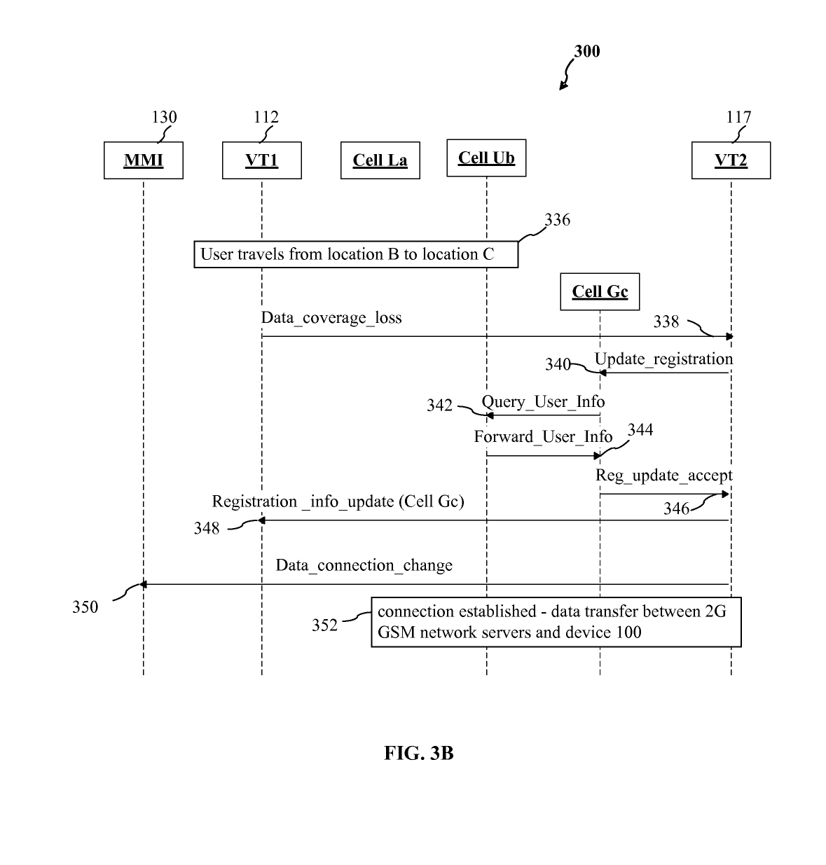

Embodiments may also be implemented in processes or methods. For example, FIGS. 3A and 3B show a method 300 of maintaining continuity by migrating service provided to user equipment among three different technology networks in a mixed technology network, according to an exemplary embodiment. Embodiments described with respect to FIGS. 1, 2A, and 2B and other embodiments in accordance with the technical subject matter described herein may operate according to exemplary method 300 or other methods evident from the present disclosure.

Method 300 provides an exemplary method for concurrent connections to different networks and seamless transition of one or more services in a single-SIM dual-active (SSDA) cellular device operating in a mixed technology cellular network. With reference to FIGS. 1, 2A, and 2B, components involved in method 300 may be MMI 130, first modem 110 providing first virtual terminal VT1 112, second modem 115 providing second virtual terminal VT2 117, cell La in first region 210, cell Ub in second region 215 and cell Gc in third region 220. A vertical line extends below each of these network connection participants in FIGS. 3A and 3B to show which participants are involved in various steps.

Method 300 is presented as though a user were geographically traversing from location A to location B to location C as shown in FIG. 2B. Obviously, a user may traverse in any direction and the types and localities of the networks may be different in other embodiments, in which cases method 300 may be adjusted accordingly.

Method 300 comprises steps 302-352 shown in FIGS. 3A and 3B. Steps 302-334 are shown in FIG. 3A, and steps 336-352 are shown in FIG. 3B. However, other embodiments may operate according to other methods. Other structural and operational embodiments will be apparent to persons skilled in the relevant art(s) based on the discussion of embodiments. No order of steps is required unless expressly indicated or inherently required. Steps may be merged or split. Steps may also be implemented sequentially or concurrently. There is no requirement that a method embodiment implement all of the steps illustrated in FIGS. 3A and 3B. FIGS. 3A and 3B show one of many possible embodiments. Embodiments may implement fewer, more or different steps in different orders than shown in FIGS. 3A and 3B.

Method 300 is described with respect to a migratory data service. However, method 300 and other embodiments may be applied to one or more migratory services of any type, such as voice data. Communications may be transmitted in FIGS. 3A and 3B between cells and first modem 110 and second modem 115 according to the communication protocols associated with the corresponding communication network types, as would be known by persons skilled in the relevant art(s). Method 300 begins with step 302 shown in FIG. 3A. In step 302, MMI 130 or an application may direct or control first modem 110 or VT1 112 to start a data connection.

In step 304, first modem 110 wirelessly transmits through first antenna 135 a request for an initial registration. Assuming the user associated with device 100 is at location A as shown in FIG. 2B, the initial registration is received by cell La comprising one or more 4G LTE network elements. As such, in this example, the communications associated with the initial registration and/or subsequent communications related to cell La may be performed according to an LTE compatible communication protocol. In step 306, cell La transmits a registration acceptance, which is received by first modem 110.

In step 308, first service transition (ST1) logic 111 in first modem 110 provides registration information (about registration with cell La) to second service transition (ST2) logic 116 in second modem 115. This way, the first and second virtual terminals VT1 112, VT2 117 are aware of the registration for purposes of maintaining continuity by migrating the data service if the connection to the 4G LTE network becomes unavailable.

In step 310, first modem 110 wirelessly transmits through first antenna 135 a request to establish a connection. The request for connection is received by cell La. In step 312, cell La transmits an assigned connection, which is received by first modem 110.

In step 314, ST1 logic 111 in first modem 110 provides assigned connection context information (about the connection(s) with cell La) to ST2 logic 116 in second modem 115. This way, the first and second virtual terminals VT1 112, VT2 117 are aware of the connection(s) and the context of the connection(s) for purposes of maintaining continuity by migrating the data service if the connection to the 4G LTE network becomes unavailable.

In step 316, first modem 110 provides an indication to MMI 130 that the data connection MMI 130 requested in step 302 is ready for use. As indicated by step 318, with the data service connection established, data is transferred through the connection between 4G LTE network servers and device 100.

In step 320, the user with device 100 travels from location A in first region 210 to location B in second region 215, which leads to the need for the migration of the data service to maintain continuity in the data service. A 3G UMTS network is available in second region 215. In this embodiment, first modem 110 is capable of communicating with a plurality of different networks in the mixed technology network, including the 4G LTE network and the 3G UMTS network. Thus, ST1 logic 111 in first modem 110 can accomplish migration of the network registration and connection(s).

The appropriate time for migration may vary between embodiments. Respective network signal strength may be tracked and applied to transition or migration thresholds. For example, as the user travels from location A towards location B, decreasing signal strength in 4G LTE network and increasing or maintained strength in the 3G UMTS network may be tracked and appropriate thresholds may be applied to determine an appropriate time to migrate the data service. Of course, migration may also occur when device 100 loses a connection. In this case, network elements in different networks may still communicate with one another.

In step 322, first virtual terminal VT1 112 provided by first modem 110, or one of its components such as ST1 logic 111, transmits a request to 3G UMTS network cell Ub to update the registration with 4G LTE network cell La. In this example, the communications associated with the request and subsequent communications related to cell Ub may be performed according to an UMTS compatible communication protocol.

In step 324, to process the requested registration update, 3G UMTS network cell Ub transmits a query for user information to 4G LTE network cell La. In step 326, cell La transmits the requested user information, which is received by cell Ub.

In step 328, 3G UMTS network cell Ub transmits an acceptance of the registration update requested in step 322, which is received by first virtual terminal VT1 112 provided by first modem 110, or one of its components such as ST1 logic 111.

In step 330, ST1 logic 111 in first modem 110 provides a registration information update (about registration with cell Ub) to ST2 logic 116 in second modem 115. This way, the first and second virtual terminals VT1 112, VT2 117 are aware of the registration for purposes of maintaining continuity by migrating the data service if the connection to the 4G LTE network becomes unavailable.

In step 332, first modem 110 or ST1 logic 111 in first modem 110 provides an indication to MMI 130 that the data connection MMI 130 requested in step 302 has been changed, but remains ready for use. Awareness that the data service is provided by a 3G UMTS network may result in a change of operation by the application. As indicated by step 334, with the data service connection successfully migrated, data is transferred through the migrated connection between 3G UMTS network servers and device 100.

Method 300 transitions from FIG. 3A to FIG. 3B when traversing from step 334 to step 336. In step 336, the user with device 100 travels from location B in second region 215 to location C in third region 220, which requires migration of the data service to maintain continuity in the data service. A 2G GSM network is available in third region 220, and the LTE and UMTS networks are not available. In this embodiment, second modem 115 is capable of communicating with the GSM network. Second modem 115 and GSM network may already be providing a voice service to device 100. As shown in FIG. 2B, second modem 115 connects to cell Ga, cell Gb, and cell Gc to continuously provide a voice service to device 100 as the user moves from location A to location B to location C. Transition of the data service to cell Gc means that the GSM network can provide a plurality of services through a connection to second modem 115.

An appropriate time for migration may vary between embodiments. Respective network signal strength may be tracked and applied to transition or migration thresholds. For example, as the user travels from location B towards location C, decreasing signal strength in 3G UMTS network and increasing or maintained strength in the 2G GSM network may be tracked and appropriate thresholds may be applied to determine an appropriate time to migrate the data service. Of course, migration may also occur when device 100 loses a connection. In this case, network elements in different networks may still communicate with one another.

In step 338, ST1 logic 111 provides an indication of data coverage loss for the data service to ST2 logic 116. Because ST1 logic 111 provided registration, registration update and connection information in steps 308, 314 and 330, ST2 logic 116 in second modem 115 can accomplish migration of the network registration and connection(s) to maintain continuity of the data service. Also, any communications or data that first modem 110 prepared for transmission may be provided to second modem 115 for transmission to the 2G GSM network following migration.

In step 340, second virtual terminal VT2 117 of second modem 115, or a component of second modem 115 such as ST2 logic 116, transmits a request to 2G GSM network cell Gc to update the registration with 3G UMTS network cell Ub. The routing area update or registration update uses information previously provided by ST1 logic 111. The registration update request may include the number of active connection contexts that exist.

In step 342, to process the requested registration update, 2G GSM network cell Gc transmits a query for user information to 3G UMTS network cell Ub. In step 344, cell Ub transmits the requested user information, which is received by cell Gc.

In step 346, 2G GSM network cell Gc transmits an acceptance of the registration update requested in step 340, which is received by second virtual terminal VT2 117 provided by second modem 115, or a component of second modem 115 such as ST2 logic 116. In doing so, 2G GSM network may indicate how many active connection contexts can be migrated without interruption. Some data services may have to be combined into one connection due to a lower data rate provided by the 2G GSM network. Connection contexts that are not transferred by migration or merger may need to be re-established.

In step 348, ST2 logic 116 in second modem 115 provides a registration information update (about registration with cell Gc) to ST1 logic 111 in first modem 110. This way, the first and second virtual terminals VT1 112, VT2 117 are aware of the registration for purposes of maintaining continuity by migrating the data service if the connection to the 4G LTE network or 3G UMTS network becomes available, such as if the user of device 100 returned device 100 to second region 215 or first region 210.

In step 350, ST2 logic 116 in second modem 115 provides an indication to MMI 130 that the data connection MMI 130 requested in step 302 has been changed, but remains ready for use. Awareness that the data service is provided by a 2G GSM network may or may not result in a change of operation by the application. As indicated by step 352, with the data service connection successfully migrated, data is transferred through the migrated connection between 2G GSM network servers and device 100.

Accordingly, service migration may continue as the user of device 100 geographically traverses a mixed technology network. Although not shown in FIGS. 3A and 3B, if the user reaches an area served by 4G LTE or 3G UMTS after being in location C, first modem 110 may detect the 4G LTE or 3G UMTS network and notify second modem 115. Or, more specifically, ST1 logic 111 in first modem 110 may notify ST2 logic 116 in second modem 115. MMI 130 may also be notified. MMI 130 or a relevant application may suspend data transmission and instruct VT2 117 provided by second modem 115 to remove data services. Second modem 115 may then abort its connection, but maintain all connection contexts or deregister data services from the 2G GSM network. Second modem 115 may then inform MMI 130 or an application that all connections are aborted. Then MMI 130 or the relevant application may inform VT1 112 provided by first modem 110 to restore data services. First modem 110 may perform a tracking area update on a 4G LTE network cell or a routing area update on a 3G UMTS network cell to transfer the registration of data services from the 2G GSM network element serving VT2 117 to the network element (e.g., cell tower, etc.) serving VT1 112. First modem 110 would provide the active connection context information in this registration update procedure. First modem 110 (or its virtual modem) may manage the connection contexts based on the registration result. As before, to be prepared for subsequent migration, ST1 logic 111 in first modem 110 provides registration and assigned connection context information to ST2 logic 116 in second modem 115.

As such, one or more services may be migrated back and forth between different technology networks in a seamless fashion, to transition user devices to a higher capability network (e.g., a network having higher data rates, better quality connections, higher reliability, etc.) when available, and to transition user devices to a lower capability network when a higher capability network becomes unavailable. Furthermore, the transitioning between networks may be performed in a manner so that a user of a device does not necessarily notice that a service has been transitioned.

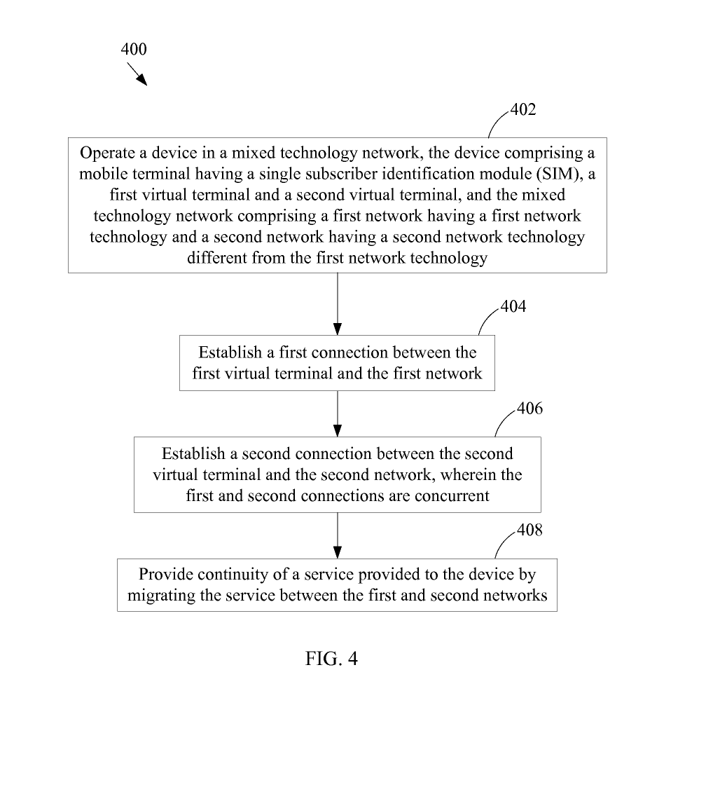

Embodiments described herein may be implemented in various ways to function according to method 300 of FIGS. 3A and 3B and/or according to other methods to enable continuity to be maintained while migrating services in a mixed technology network. For instance, FIG. 4 shows a flowchart 400 providing a process for maintaining continuity by migrating service provided to user equipment among different technology networks in a mixed technology network, according to an exemplary embodiment. In an embodiment, device 100 may operate according to flowchart 400. Flowchart 400 is described as follows. Further structural and operational embodiments will be apparent to persons skilled in the relevant art(s) based on the following description.

Flowchart 400 begins with step 402. In step 402, a device is operated in a mixed technology network, the device comprising a mobile terminal having a single subscriber identification module (SIM), a first virtual terminal and a second virtual terminal, and the mixed technology network comprising a first network having a first network technology and a second network having a second network technology different from the first network technology. For example, as described above, device 100 may operate in a mixed technology network, such as network 200 shown in FIG. 2, which includes a first network (e.g., a 4G network such as LTE) in a first region 210, a second network (e.g., a 3G network such as UMTS) in a second region 215, and a third network (e.g., a 2G network such as GSM) in third region 220. As shown in FIG. 1, device 100 includes UE 105, which may be a mobile terminal, and includes a single SIM 125. UE 105 includes a first virtual terminal 112 and a second virtual terminal 117.

In step 404 of flowchart 400, a first connection is established between the first virtual terminal and the first network. For instance, as shown in FIG. 2B, first virtual terminal 112 of device 100 may establish a first connection 236 for a data service through the 4G network LTE, when device 100 is at location A. Alternatively, first virtual terminal 112 of device 100 may establish a first connection 237 for a data service through the 3G network UMTS, when device 100 is at location B. With reference to FIG. 3A, the first connection may be established by first virtual terminal 112 as indicated in steps 302-318 (at location A), or as indicated in steps 320-334 (at location B).

In step 406 of flowchart 400, a second connection is established between the second virtual terminal and the second network, wherein the first and second connections are concurrent. For instance, as shown in FIG. 2B, second virtual terminal 117 of device 100 may establish a second connection 241 for a voice service through the 2G network GSM, when device 100 is at location A or at location B.

In step 408 of flowchart 400, continuity of a service is provided to the device by migrating the service between the first and second networks. For instance, as shown in FIG. 2B, when device 100 is moved from location A to location B, continuity of the data service may be performed in device 100 by first virtual terminal 112 migrating the data service between the first network (e.g., the 4G LTE network) and the second network (e.g., the 3G UMTS network). When device 100 is moved from location B to location C, continuity of the data service may be performed in device 100 by second virtual terminal 117 taking over and migrating the data service between the second network and the third network (e.g., the 2G GMS network). This migration of the data service is enabled by ST1 logic 111 of first virtual terminal 112 having previously provided ST2 logic 116 of second virtual terminal 117 with the registration information and connection context for the connection previously maintained with the data service by first virtual terminal 112 (step 330 of FIG. 3A). With reference to FIG. 3B, this migration of the data service is indicated in steps 336-352, and provides continuity in the data service.

It is noted that in step 408, continuity of the data service may be provided to device 100 by migrating the data service from the 2G GSM network to the 3G UMTS network (or directly to the 4G LTE network) as described above.

### V. Conclusion

While various embodiments have been described above, it should be understood that they have been presented by way of example only, and not limitation. It will be understood by those skilled in the relevant art(s) that various changes in form and details may be made to such embodiments without departing from the spirit and scope of the subject matter of the present application.

Systems, apparatuses and methods have been described for seamless transition of data services in a single-SIM multi-active (SSMA) cellular device operating in a mixed technology cellular network. An SSMA device provides multiple virtual terminals capable of simultaneously maintaining multiple active services on different technology networks. The virtual terminals maintain service continuity by coordinating to seamlessly migrate data services from one network technology to another as a user geographically navigates a mixed technology network. This technology may be implemented in user equipment without modifying the various networks in the mixed technology network.

Advantages of this technology include reducing disruptions in service by maintaining connections through service migration, improving user experience and satisfaction with their UE and network providers, and reducing costs for users by using a single SIM design.

Embodiments are not limited to the functional blocks, detailed examples, steps, order or the entirety of subject matter presented in the figures, which is why the figures are referred to as exemplary embodiments. A device, apparatus or machine may comprise any one or more features described herein in any configuration. A method may comprise any process described herein, in any order, using any modality.

Devices (e.g., apparatuses) may be digital, analog or a combination thereof.

Devices may be implemented with any semiconductor process or semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such alternative devices may require alternative configurations other than the configuration illustrated in embodiments presented herein.

Techniques, including methods, described herein may be implemented by hardware (digital and/or analog) or a combination of hardware and software and/or firmware. Techniques described herein may be implemented by one or more components. For instance, first modem 110, first ST1 logic 111, first VT1 112, second modem 115, second ST2 logic 116, second VTI 117, service continuity logic 120, SIM 125, MMI 130, and flowchart 400 may be implemented in hardware, or hardware and any combination of software and/or firmware, including being implemented as computer program code/instructions configured to be executed in one or more processors and stored in a computer readable storage medium, being implemented as hardware logic/electrical circuitry, and/or being implemented together in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions. Logic as mentioned herein may be implemented in hardware and any combination of software and/or firmware, including being implemented as computer program code/instructions configured to be executed in one or more processors and stored in a computer readable storage medium.

Device 100 may be any type of mobile device described herein, which may optionally be handheld, including a smart phone or other type of cell phone, a laptop, a netbook, tablet computer, etc. Device 100 may have a housing that houses one or more of the components shown in FIG. 1, and first and second antennas 135 and 140 may be internal to, external to, or incorporated in or on the material of the housing, and may be any suitable type of antennas. Device 100 may further include one or more of a display (e.g., a liquid crystal display, etc.), a keyboard (physical or virtual), one or more speakers, a camera, one or more user interface elements (in addition to the display) such as one or more buttons, a thumbwheel, a touch pad, a microphone, etc.

Embodiments may comprise computer program products comprising program modules (e.g., in the form of program code, instructions, or software as well as firmware) stored on any computer useable medium, which may be integrated in or separate from other components. Such program code, when executed in one or more processors, causes a device to operate as described herein.

Devices in which embodiments may be implemented may include storage, such as storage drives, memory devices, and further types of computer-readable storage media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program instructions, e.g., program modules, comprising computer executable instructions that, when executed, provide and/or maintain one or more aspects of functionality described herein with reference to the figures, as well as any and all components, steps and functions therein and/or further embodiments described herein.

As used herein, the terms “computer program medium,” “computer-readable medium,” and “computer-readable storage medium” are used to generally refer to media such as a hard disk associated with a hard disk drive, a removable magnetic disk, a removable optical disk, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

Proper interpretation of subject matter described herein and claimed hereunder is limited to patentable subject matter under 35 U.S.C. §101. Subject matter described in and claimed based on this patent application is not intended to and does not encompass unpatentable subject matter. As described herein and claimed hereunder, a method is a process defined by 35 U.S.C. §101. As described herein and claimed hereunder, each of a circuit, device, apparatus, machine, system, computer, module, media and the like is a machine and/or manufacture defined by 35 U.S.C. §101.

While a limited number of embodiments have been described, those skilled in the art will appreciate numerous modifications and variations there from. Embodiments have been presented by way of example only, and not limitation. It will be apparent to persons skilled in the relevant art(s) that various changes in form and details can be made therein without departing from the spirit and scope of the disclosed technologies. The exemplary appended claims encompass embodiments and features described herein, modifications and variations thereto as well as additional embodiments and features that fall within the true spirit and scope of the disclosed technologies. Thus, the breadth and scope of the disclosed technologies should not be limited by any of the above-described exemplary embodiments, but should be defined only in accordance with the following claims and their equivalents.

What is claimed is:

1. A device comprising:
a mobile terminal comprising:
a plurality of virtual terminals;
a first configuration providing the plurality of virtual terminals capable of simultaneously providing multiple active cellular network connections to multiple networks in a mixed technology network, the multiple networks comprising a first network having a first network technology and a second network having a second network technology different from the first network technology; and
a second configuration capable of providing continuity of a service provided to the device by migrating the service between the first and second networks.

2. The device of claim 1, further comprising:
a subscriber identification module (SIM); and
an application layer.

3. The device of claim 2, wherein the first configuration comprises:
a first virtual terminal provided by a first modem coupled to the SIM, coupled to the application layer and configured to establish a first connection to the first network to provide the service; and
a second virtual terminal provided by a second modem coupled to the SIM, coupled to the application layer and configured to establish a second connection to the second network to provide the service.

4. The device of claim 3, wherein the second configuration comprises:
a service continuity logic configured to:
provide first registration information and connection context for the first connection to the second modem;
migrate the service from the first network to the second network by using the first registration information to perform a registration update on the second network;
provide second registration information and connection context for the second connection to the first modem; and
migrate the service from the second network to the first network by using the second registration information to perform a registration update on the first network.

5. The device of claim 4, wherein the service continuity logic comprises:
a first service transition unit in the first virtual terminal; and
a second service transition unit in the second virtual terminal

6. The device of claim 5, wherein the service is a data service and wherein the second virtual terminal is configured to establish the second connection to the second network to provide a voice service in addition to the data service.

7. The device of claim 6, wherein the first virtual terminal is configured to establish a third connection to a third network, having a third network technology different from the first and second network technologies, to provide the service.

8. The device of claim 7, wherein the first network technology comprises Long Term Evolution (LTE), the second network technology comprises Universal Mobile Telecommunications System (UMTS) and the third network technology comprises global system for mobile communications (GSM).

9. A method comprising:
operating a device in a mixed technology network, the device comprising a mobile terminal having a single subscriber identification module (SIM), a first virtual terminal and a second virtual terminal, and the mixed technology network comprising a first network having a first network technology and a second network having a second network technology different from the first network technology;
establishing a first connection between the first virtual terminal and the first network;
establishing a second connection between the second virtual terminal and the second network, wherein the first and second connections are concurrent; and
providing continuity of a service provided to the device by migrating the service between the first and second networks.

10. The method of claim 9, further comprising:
providing first registration information and connection context for the first connection to the second virtual terminal when the service is provided through the first connection; and
providing second registration information and connection context for the second connection to the first virtual terminal when the service is provided through the second connection.

11. The method of claim 10, further comprising:
providing an indication of loss of the first connection; and
migrating the service from the first network to the second network by using the first registration information to perform a registration update on the second network; and

12. The method of claim 10, further comprising:
providing an indication of availability of the first network; and
migrating the service from the second network to the first network by using the second registration information to perform a registration update on the first network.

13. The method of claim 10, further comprising:
wherein the service is a data service,
providing a voice service to the device through the first or second connection.

14. The method of claim 9, further comprising:
establishing a third connection between the first virtual terminal and a third network having a third network technology different from the first and second network technologies; and
providing continuity of the service provided to the device by migrating the service between the first, second and third networks.

15. The method of claim 14, further comprising:
providing third registration information and connection context for the third connection to one or both the first and second virtual terminals.

16. The method of claim 9, further comprising:
providing notice of change of service connection to an application layer for each migration of the service, the application layer being common to the first and second virtual terminals.

17. A system comprising:
a mixed technology network comprising:
a first network having a first technology to provide a service to a device; and
a second network having a second technology different from the first technology to provide the service to the device, the device comprising:
a first virtual terminal comprising a first modem configured to establish a first connection to the first network;
a second virtual terminal comprising a second modem configured to establish a second connection to the second network, wherein the first and second connections can be concurrent; an
a service continuity logic configured to provide continuity of the service by migrating the service between the first and second connections.

18. The system of claim 17, wherein at least one of the first and second virtual terminals and at least one of the first and second networks are configured to provide an additional service to the device though at least one of the first and second connections.

19. The system of claim 17, further comprising:
the mixed technology network further comprising:
a third network having a third technology different from the first and second technologies to provide a service to the device;
wherein the first modem is further configured to establish a third connection to a third network; and
wherein the service continuity logic is further configured to provide continuity of the service by migrating the service between the first, second and third connections.

20. The system of claim 17, wherein the service continuity logic is configured to:
provide first registration information and connection context for the first connection to the second modem;
migrate the service from the first network to the second network by using the first registration information to perform a registration update on the second network;
provide second registration information and connection context for the second connection to the first modem; and
migrate the service from the second network to the first network by using the second registration information to perform a registration update on the first network.
